(19) United States
(12) Patent Application Publication
(10) Pub. No.: US 2011/0133045 A1
(43) Pub. Date: Jun. 9, 2011

(54) TREE STAND SUPPORT SYSTEM

(76) Inventor: Brian Donald Merle Sorum, Oakes, ND (US)

(21) Appl. No.: 12/632,603

(22) Filed: Dec. 7, 2009

(51) Int. Cl. F16M 13/02; B23P 11/00

(52) U.S. Cl. 248/219.4; 29/525.08

(57) ABSTRACT

A tree stand attachment device for mounting a tree stand to a tree comprising: at least two vertical posts; at least two horizontal posts extending from the at least two vertical posts; at least two v-shaped tree grips attached to the at least two vertical posts, said tree grips abut the tree trunk; at least two straps, where said straps wrap around the tree trunk to secure the attachment device onto the tree; and at least two buckles, where said buckles receive and secure the at least two straps. The v-shaped tree grips may include a gripping surface to abut the tree. The tree stand attachment device may further include a plurality of locking pins to secure the stand on the attachment device.

### BACKGROUND OF THE INVENTION

1. Field of Invention

The present invention relates to a tree stand support system for easy tree stand installation.

2. Description of Related Art

Tree stands are platforms that are used by hunters or photographers in an open field or wooded area. Tree stands may be enclosed or open platforms and generally comprise three different varieties: a climbing stand; ladder stand; or hanging stand. As the title suggests a climbing stand is a tree stand that may include a top portion and a bottom portion that the hunter may use to climb up the tree and mount in place the desired height. A ladder tree stand is a tree stand that is primarily stationary because the ladder is usually attached to the platform of the stand and is mounted securely to the tree. A climbing tree stand provides more mobility as opposed to a ladder tree stand. Hanging tree stands utilize chains or cables to secure them to the tree and also are also fairly stationary. Tree stands allow hunters to have an optimal view of game they may be hunting and increases their range of view from the elevated hunting position.

Many times hunters utilize multiple tree stands in order to achieve multiple positions of elevated vantage points. Consequently the use of multiple stationary locations may be an expensive endeavor due to the higher costs of stationary stands. Use the climbing tree stand for multiple locations can be cumbersome and difficult for movement from location to location. It would be advantageous to have a hybrid tree stand attachment device that may provide a means to easily mount a platform and conversely to easily remove the platform for movement to an alternative location. With mobile platform attachment, a hunter may have multiple positions secured without the expense of stationary tree stands and less cumbersome than using the climbing tree stand that is used in some instances.

### SUMMARY OF THE INVENTION

The present invention relates to a tree stand attachment device for mounting a tree stand to a tree comprising: at least two vertical posts; at least two horizontal posts extending from the at least two vertical posts; at least two v-shaped tree grips attached to the at least two vertical posts, said tree grips abut the tree trunk; at least two straps, where said straps wrap around the tree trunk to secure the attachment device onto the tree; and at least two buckles, where said buckles receive and secure the at least two straps. The v-shaped tree grips may include a gripping surface to abut the tree. The tree stand attachment device may further include a plurality of locking pins to secure the stand on the attachment device. In one exemplary embodiment, the tree stand attachment device includes a horizontal post extending from one of the v-shaped grips, where said horizontal post attaches to a vertical post extending from the tree stand.

### BRIEF DESCRIPTION OF DRAWINGS

FIG. 1 depicts a tree stand support device according to the present invention.

FIG. 2 depicts a tree stand attached to the tree stand support device according to the present invention.

### DETAILED DESCRIPTION

The present invention provides a tree stand attachment device that connects to a tree and provides a means to secure a tree stand platform for use by a hunter. The installation of the tree stand on the tree stand attachment device according to the present invention is easier to maneuver than the traditional tree stand and provides the hunter with the opportunity to have multiple tree stand locations in one particular area. The tree stand attachment device according to the present invention may also remain attached to the tree for a significant amount time without concern for theft because the platform and further attachments may be removed and therefore the tree stand attachment becomes a permanent attachment for use in the woods. The tree stand attachment device provides an installation of a tree stand with less effort than associated with the tree stands of the prior art.

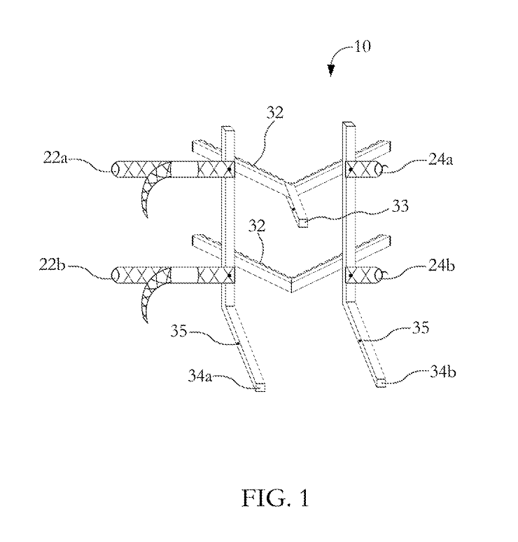

FIG. 1 depicts the tree stand attachment device according to the present invention. A tree stand attachment Device 10 is depicted in FIG. 1. The tree stand attachment Device 10 includes two vertical posts 36a, 36b that extend parallel to the subject tree that the tree stand support device is secured thereto. Two horizontal Posts 34a, 34b extend from the vertical Posts 36a, 36b. The horizontal Posts 34a, 34b receive and support the tree stand platform when mounted onto the tree stand attachment Device 10. The tree stand attachment Device 10 further includes two V-shaped tree Grips 32 that abut the trunk of a tree that the tree stand attachment Device 10 is mounted thereon. The tree Grips 32 includes a gripping surface that abuts the trunk of the tree to provide a non-slipping or a reduced slipping surface between the tree stand attachment Device 10 and the tree. The use of the gripping surface may increase the coefficient of friction and thus provide a firmer support for the attachment Device 10.

The hunter may mount the tree stand attachment Device 10 by using Straps 22a, 22b to wrap around the trunk of the tree and secure the straps within Buckles 24a, 24b. Once mounted upon the tree trunk, the tree stand attachment Device 10 provides a means to easily install a tree stand upon the attachment device. The horizontal posts 34a, 34b may receive the platform and include locking Pins 35 on each respective post. The locking Pin 35 locks and secures the platform of a tree stand into place. The top V-shaped tree Grip 32 includes an additional horizontal Post 33 that extends outwardly and parallel to the horizontal Post 34a, 34b. The horizontal Post 33 includes a locking Pin 37 that locks a vertical top post for the tree stand into place.

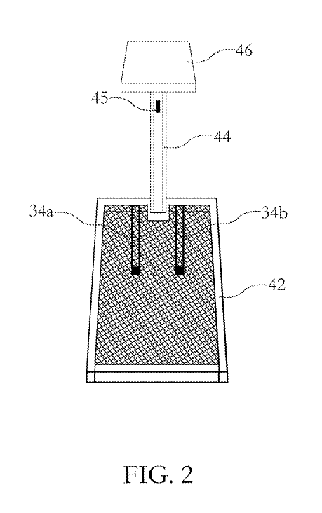

FIG. 2 depicts the mounting of a Tree Stand 42 upon the tree attachment Device 10. As noted a Platform 42 is mounted upon the horizontal Posts 34a, 34b and locked into place with the respective locking Pins 35. The tree stand 42 further includes a vertical post 44 that extends upwardly at a 90 degree angle from the Tree Stand 42, where the vertical Post 44 may be locked into place on the horizontal Post 33 with the locking Pin 37. On top of the vertical Post 44 a small armrest or platform may be provided for the tree stand. Once the hunter has finished his or her use of the tree Stand 42, it may be easily removed and taken to another tree attachment device mounted at a different position on a different tree. The use of the tree stand attachment Device 10 reduces the cumbersome installation and additional effort that it may be associated with a climbing tree stand or other traditional tree stands that may be used.

The tree stand attachment Device 10 provides the hunter with a more economical and versatile structure to easily mount and install a tree stand in the woods. Once the tree stand attachment Device 10 is attached to the tree it may remain in place and be used at a later date by simply installing a tree stand upon the attachment Device 10. When the hunters desire to use the tree stand, they may carry a tree stand up the tree and connect it to the attachment Device 10 and lock the stand into place using the locking pins provided. Once secured to the tree, the hunter may use the tree stand as desired and upon leaving may unlock the locking pins and remove the tree stand leaving the tree stand attachment Device 10 in place for future use. Multiple tree stand attachment devices may be purchased and consequently making the use of multiple tree stands more affordable than buying multiple tree stands of the prior art. The instant invention has been shown and described in what it considers to be the most practical and preferred embodiments. It is recognized, however, that departures may be made there from within the scope of the invention and that obvious modifications will occur to a person skilled in the art.

What is claimed is:

1. A tree stand attachment device for mounting a tree stand to a tree comprising:
a. at least two vertical posts;
b. at least two horizontal posts extending from the at least two vertical posts;
c. at least two v-shaped tree grips attached to the at least two vertical posts, said tree grips abut the tree trunk;
d. at least two straps, where said straps wrap around the tree trunk to secure the attachment device onto the tree; and
e. at least two buckles, where said buckles receive and secure the at least two straps.

2. The tree stand attachment device according to claim 1, wherein the v-shaped tree grips include a gripping surface to abut the tree.

3. The tree stand attachment device according to claim 1, further including a plurality of locking pins to secure the stand on the attachment device.

4. The tree stand attachment device according to claim 1, further including a horizontal post extending from one of the v-shaped grips, where said horizontal post attaches to a vertical post extending from the tree stand.

5. A tree stand attachment device for mounting a tree stand to a tree comprising:
a. two vertical posts;
b. two horizontal posts extending from the vertical posts;
c. two v-shaped tree grips attached to the at least two vertical posts, said tree grips abut the tree trunk;
d. two straps, where said straps wrap around the tree trunk to secure the attachment device onto the tree; and
e. two buckles, where said buckles receive and secure the at least two straps.

6. The tree stand attachment device according to claim 5, wherein the v-shaped tree grips include a gripping surface to abut the tree.

7. The tree stand attachment device according to claim 5, further including a plurality of locking pins to secure the stand on the attachment device.

8. The tree stand attachment device according to claim 5, further including a horizontal post extending from one of the v-shaped grips, where said horizontal post attaches to a vertical post extending from the tree stand.

9. A method of mounting a tree stand comprising the steps of:
a. mounting a tree attachment device to a tree, wherein said tree attachment device includes:
i. two vertical posts;
ii. two horizontal posts extending from the vertical posts;
iii. two v-shaped tree grips attached to the at least two vertical posts, said tree grips abut the tree trunk;
iv. two straps, where said straps wrap around the tree trunk to secure the attachment device onto the tree; and
v. two buckles, where said buckles receive and secure the at least two straps;
b. inserting a tree stand platform onto said two horizontal posts; and
c. inserting at least one locking pin, where said at least one locking pin secures the platform in place.

10. The method of mounting a tree stand further comprising the step of:
a. inserting a locking pin into a vertical post, where said vertical post extends from the tree stand.
